(19) United States
(12) Patent Application Publication
(10) Pub. No.: US 2022/0092424 A1
(43) Pub. Date: Mar. 24, 2022

(54) METHODS, SYSTEMS, APPARATUS AND ARTICLES OF MANUFACTURE TO APPLY A REGULARIZATION LOSS IN MACHINE LEARNING MODELS

(71) Applicant: Nielsen Consumer LLC, New York, NY (US)

(72) Inventors: Emilio Almazán Manzanares, Alcorcón (ES); Javier Tovar Velasco, Cigales (ES); Alejandro de la Calle, Valladolid (ES)

(21) Appl. No.: 17/478,582

(22) Filed: Sep. 17, 2021

Related U.S. Application Data
(60) Provisional application No. 63/080,564, filed on Sep. 18, 2020.

(51) Int. Cl. G06N 3/08; G06N 3/04

(52) U.S. Cl. CPC G06N 3/082; G06N 3/0481

(57) ABSTRACT

Methods, systems, apparatus and articles of manufacture are disclosed herein to apply a regularization loss in machine learning models. An example apparatus includes at least one memory, instructions in the apparatus, and processor circuitry to execute the instructions to identify at least one neural network filter with filter norm values below a filter norm threshold, the filter norm values corresponding to filter functionality, a higher level of filter functionality corresponding to decreased filter death, correct the filter norm values by applying a survival loss function, the survival loss function including one or more hyperparameters, reduce filter death by adjusting the one or more hyperparameters used to define a minimum filter norm for identification of filter functionality, the adjustment based on neural network filter performance, a functional filter to return non-zero parameter values indicating reduction of filter death, and train the neural network for use in continual learning with the at least one neural network filter corrected using the survival loss function.

### RELATED APPLICATION

This patent claims the benefit of U.S. Provisional Patent Application No. 63/080,564, filed Sep. 18, 2020, entitled “Methods, Systems, Apparatus and Articles of Manufacture to Apply a Regularization Loss in Machine Learning Models.” The entire disclosure U.S. Provisional Patent Application No. 63/080,564 is hereby incorporated by reference in its entirety.

### FIELD OF THE DISCLOSURE

This disclosure relates generally to computer processing, and, more particularly, to methods, systems, apparatus and articles of manufacture to apply a regularization loss in machine learning models.

### BACKGROUND

Deep neural networks (DNNs) have revolutionized the field of artificial intelligence (AI) with state-of-the-art results in many domains including computer vision, speech processing, and natural language processing. DNN-based learning algorithms can be focused on how to efficiently execute already trained models (e.g., using inference) and how to evaluate DNN computational efficiency via image classification. Improvements in efficient training of DNN models can be useful in areas of machine translation, speech recognition, and recommendation systems, among others.

### BRIEF DESCRIPTION OF THE DRAWINGS

FIG. 1 is a block diagram illustrating example neural network training circuitry using regularization modifying circuitry constructed in accordance with teachings of this disclosure.

FIG. 2 is a block diagram of the regularization modifying circuitry of FIG. 1 constructed in accordance with teachings of this disclosure.

FIG. 3 is a flowchart representative of machine readable instructions that may be executed by example processor circuitry to implement the regularization modifying circuitry of FIGS. 1-2.

FIG. 4 is a flowchart representative of machine readable instructions that may be executed by example processor circuitry to perform regularization during the neural network training process using the regularization modifying circuitry of FIGS. 1-2.

FIG. 5 illustrates example graphical and tabulated comparisons of model filter norms for models trained using different optimizers (e.g., Adam, SGD Nesterov) in combination with an L2 regularizer.

FIG. 6 illustrates an example reduction of filter norms over time using an Adam optimizer in combination with an L2 regularizer.

FIG. 7A illustrates an example model filter norm as a result of training using an Adam optimizer without an L2 regularizer.

FIG. 7B illustrates an example status of death filters across layers of a neural network, indicating higher percentage of filter death in deeper layers compared to shallower layers of the neural network.

FIG. 8 illustrates an example percentage of filter death for a first and a second iteration during model training using an Adam optimizer in combination with an L2 regularizer.

FIG. 9A illustrates an example graphical representation of a survival loss function.

FIG. 9B illustrates an example filter norm during a first iteration with and without the use of the survival loss function of FIG. 9A.

FIG. 9C illustrates an example filter norm during a second iteration with and without the use of the survival loss function of FIG. 9A.

FIG. 10 illustrates example results associated with decreased filter death in the presence of a survival loss function, including the influence of hyperparameters on accuracy.

FIG. 11 is a block diagram of an example processing platform including processor circuitry structured to execute the example machine readable instructions of FIGS. 3-4 to implement the regularization modifying circuitry of FIGS. 1-2.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real-world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Deep neural networks (DNNs) have revolutionized the field of artificial intelligence (AI) with state-of-the-art results in many domains including computer vision, speech processing, and natural language processing. More specifically, neural networks are used in machine learning to allow a computer to learn to perform certain tasks by analyzing training examples. For example, an object recognition system can be fed numerous labeled images of objects (e.g., cars, trains, animals, etc.) to allow the system to identify visual patterns in such images that consistently correlate with a particular object label. DNNs rely on multiple layers to progressively extract higher-level features from raw data input (e.g., from identifying edges of a human being using lower layers to identifying actual facial features using higher layers, etc.).

Deep neural networks can be difficult to train regardless of the task the DNN is used to solve. For example, in a neural network, each neuron produces an output with parameters including a signal from all incoming connecting neurons, weights for the input, an activation function, and the activation function threshold. Complex networks with many neurons can include an exceedingly large number of free parameters (e.g., total number of neuron synapses and/or thresholds). The training of such parameters creates a numerical challenge, given that an objective function (e.g., a loss function) that requires optimization becomes highly non-convex, such that the parameter space with respect to the loss function can be highly non-convex (e.g., includes local minima and/or local maxima, such that weights that are permutable across layers produce multiple solutions for any minima that will achieve the same result). Identifying an acceptable local minimum therefore requires careful assessment to identify a suitable combination of initial parameter values and hyper-parameters. In some examples, use of optimizers during training can ensure good convergence during the training process. As used herein, the optimizers represent algorithms or methods used to change neural network attributes (e.g., weights, learning rates, etc.) to reduce losses. As such, optimization can be used to update the parameters of the network during training, reducing losses and providing the most accurate results possible. Selection of optimizers (e.g., Adam, Momentum, etc.) determines how weights and/or learning rates of the neural network are adjusted. Differences in optimizer performance can vary in terms of accuracy (e.g., from 94.84% with Adam to 95.23% with Momentum in Cifar-10), while varying greatly with respect to convergence speed and sensitivity to hyperparameter values. Furthermore, optimizer performance can be affected by the percentage of filters with zero or almost zero norms (e.g., dead filters). For example, rectified linear units (ReLUs) can become inactive given that a large gradient flowing through a ReLU neuron can cause loss of neuron activation, such that the gradient becomes zero and the ReLU outputs the same value (e.g., a value of zero). Filtering in neural networks can be used for extraction of features from images for training purposes. For example, convolutional neural networks (CNNs) apply filters to an input to create a feature map that summarizes the presence of detected features in the input. Dead filters are not able to detect discriminative features in the input images. As such, the dead filter returns the same value regardless of the input data. In some examples, dead filters return zero values.

Additionally, such dead filters can be particularly harmful during training when followed by a rectified linear activation function (e.g., rectified linear unit (ReLU)). For example, ReLUs are piecewise linear functions that output the input directly when the input is positive. Use of ReLUs helps in overcoming the vanishing gradient problem, allowing improvement in overall model learning and performance. However, ReLUs do not get updated in the presence of dead filters, thereby preventing the gradient from backpropagating. In some examples, the dead filters can be divided into two categories: (1) filters that contain non-zero parameter values but do not get excited for any training sample (e.g., as a result of incorrect initialization, incorrect hyperparameter values, etc.), and (2) filters with all parameters returning zero (or almost zero) values. While filters with non-zero parameters can become active again for other datasets, filters with parameters returning all zeros are considered to be completely dead and not able to be revived.

Dead filters with zero values present significant limitations in continual learning scenarios, including in cases where the dataset becomes more complex over time. Such complexity can refer to an increasing number of categories (e.g., filters with non-zero parameter values, filters with zero parameter values, etc.) as well as to categories more difficult to differentiate (i.e., fine-grained). For example, additional power from the network is required to accommodate the presence of dead filters. Moreover, a general practice in continual learning is the use of a final model trained with one batch of data as the initial model of the next batch of data. This creates a challenge when training of a first iteration has killed a given number of filters that may not affect the first training, while leaving the model in poor condition for the next iteration where the complexity of the problem is higher. As such, reduction of dead filters is necessary for improved neural network training efficiency and accuracy.

Methods and apparatus disclosed herein apply a regularization loss in machine learning models to reduce filter death. Furthermore, methods and apparatus disclosed herein evaluate the effects of filter death on different optimizers. For example, a large percentage of dead filters can be present with the use of select optimizers (e.g., higher percentage of dead filters when using an Adam optimizer combined with an L2 regularizer compared to a lower percentage of dead filters when using a Momentum optimizer with the L2 regularizer). Presence of dead filters in a model is a potential problem if that model is pre-trained for use in another dataset (e.g. as part of continual learning). Methods and apparatus disclosed herein introduce a regularization term (e.g., a survival loss function) to reduce dead filters. In some examples, the survival loss function disclosed herein can be used in combination with an L2 regularizer to identify a balance between low magnitude parameters for improved generalization to avoid losing the full potential of the neural network. As shown in examples disclosed herein, in continual learning scenarios the power of the neural network can significantly diminish when the datasets of subsequent iterations become more complex over time. In the examples disclosed herein, output inaccuracies (e.g., data output not matching a target output) can be detected during neural network training to identify the presence of dead filters. For example, the return of zero values can be an indication of filter death. In some examples, a threshold can be used to identify whether filter norm is below or above the threshold to determine whether a survival loss function should be applied to a given filter to reduce filter death. Additionally, in examples disclosed herein, parameter-based optimization can be used to penalize filter(s) with norms that fall below a threshold, thereby reducing the impact of poorly performing filters with high percentages of filter death. As such, methods and apparatus disclosed herein can be used to improve the accuracy and efficiency of neural network training (e.g., CNN-based training) during continual learning.

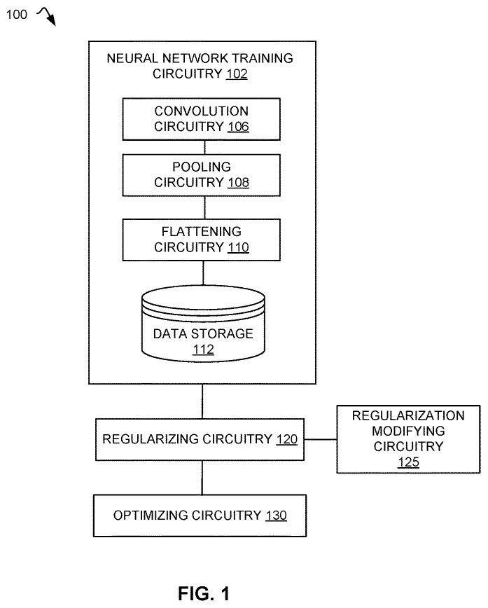

FIG. 1 is a block diagram 100 illustrating example neural network training circuitry using regularization modifying circuitry constructed in accordance with teachings of this disclosure. In the example of FIG. 1, example neural network training circuitry 102 receives input data during the training of a neural network. The neural network training circuitry 102 includes example convolution circuitry 106, example pooling circuitry 108, example flattening circuitry 110, and an example data storage 112. In some examples, the neural network training circuitry 102 is in communication with example regularizing circuitry 120 and/or example optimizing circuitry 130. In the example of convolutional neural network (CNN) training, a two-dimensional image and/or a class of the image can serve as input for the neural network training circuitry 102. As a result of the training, trained weights are obtained, representing data patterns or rules extracted from the input images. In some examples, an image can serve as an only input passed to a trained model, such that the trained model outputs the class of the image based on the learned data patterns acquired by the CNN during training using the neural network training circuitry 102.

During training, the neural network training circuitry 102 applies, in some examples, filters or feature detectors to the input image using the convolution circuitry 106. For example, the convolution circuitry 106 generates feature maps or activation maps using activation functions (e.g., ReLU, softmax, etc.). In some examples, the convolution circuitry 106 identifies different features present in an image (e.g., horizontal lines, vertical lines, etc.). In some examples, the convolution circuitry 106 generates feature maps for each given layer of the neural network. For example, each layer within a CNN can be responsible for learning a specific feature of the image. The convolution circuitry 106 applies a convolution operation to the input for passing the results to the next later of the CNN, with each convolution processing data for a given set of information. Once convolution has been performed, the pooling circuitry 108 can be used to reduce the spatial size of the convoluted feature(s), such that pooling can combine output(s) of a neuron cluster in one layer into a single neuron in a subsequent layer. For example, in order to compensate for the total amount of time taken to perform the training-based computations, pooling is used to reduce the size of an output from a previous layer of the CNN. The pooling circuitry 108 can include maximum pooling (e.g., use of the best features) and/or average pooling (e.g., using an average value of the features). Once the neural network training circuitry 102 performs pooling (e.g., using the pooling circuitry 108), the flattening circuitry 110 is used to flatten the input and pass the flattened input to a DNN that outputs the class of the object. In some examples, flattening can be used to create a one-dimensional linear vector to serve as further input into the model during continuous training. As such, the flattening circuitry 110 flattens the output of the convolutional layers to create a single long feature vector. The data storage 112 stores any information associated with the convolution circuitry 106, the pooling circuitry 108, and/or the flattening circuitry 110. The example data storage 112 of the illustrated example of FIG. 1 can be implemented by any memory, storage device and/or storage disc for storing data such as flash memory, magnetic media, optical media, etc. Furthermore, the data stored in the example data storage 112 can be in any data format such as binary data, comma delimited data, tab delimited data, structured query language (SQL) structures, image data, etc.

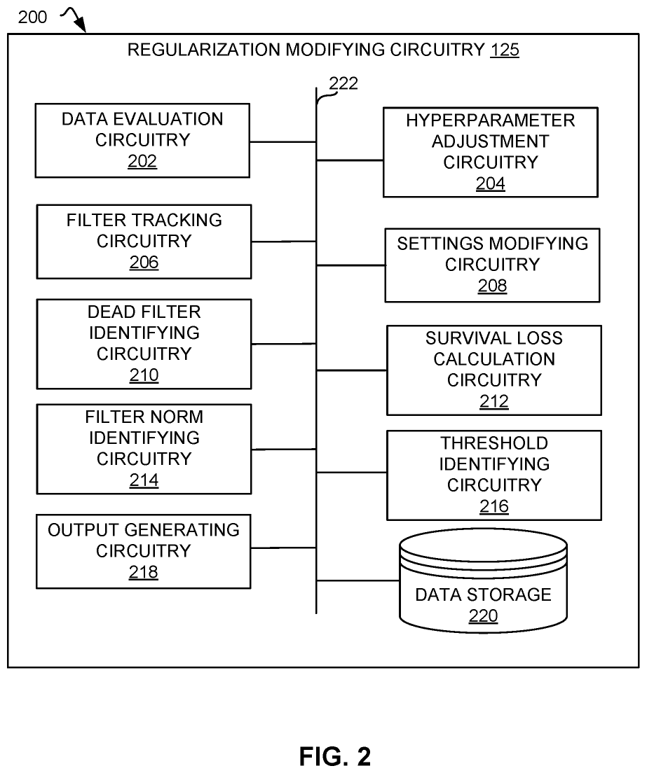

The regularizing circuitry 120 can be used to reduce neural network training-based errors by fitting a function on a given training set. In some examples, the regularizing circuitry 120 can be used to avoid overfitting. For example, the regularizing circuitry 120 can include a penalty term in an error function to control fluctuation and lack of proper fitting. This can be relevant when models perform well on a training set but shown inaccuracies when a test set is used (e.g., a set of images that the model has not encountered during training). In some examples, the regularizing circuitry 120 can reduce the burden on a specific set of model weights to control model complexity. For example, images with many features inherently include many weights, making the model prone to overfitting. The regularizing circuitry 120 reduces the impact of given weights on the loss function used to determine errors between actual labels and predicted labels. In some examples, the regularizing circuitry 120 can include regularization techniques based on L1, L2, and/or dropout regularization (e.g., where L1 regularization gives outputs in binary weights from 0 to 1 for a model's features and can be adopted for decreasing the total number of features in a large dimensional dataset, while L2 regularization disperses error terms in all weights to achieve customized final models with increased accuracy). However, any other type of regularization can be used. For example, both L1 and L2 can add a penalty by introducing a loss function using an auxiliary component (e.g., a regularization term) to penalize model complexity. The regularization term reduces the value of certain weights to allow for model simplification, thereby reducing overfitting. In L1 regularization, weights for each parameter can be assigned a value of zero or one (e.g., binary value), while in L2 regularization the resultant weights for the features are more spread out with values closer to zero. In examples disclosed herein, the regularization modifying circuitry 125 implements a regularization term (e.g., a survival loss function) to reduce dead filters, as described in more detail in connection with FIG. 2. In some examples, the survival loss function can be used in combination with an L2 regularizer to identify a balance between low magnitude parameters for improved generalization to avoid losing the full potential of the neural network.

The regularization modifying circuitry 125 can be used to evaluate the potential effects of filter death on a given model being used in a continual learning process. Overall, presence of dead filters has a negative impact on continual learning. In some examples, the regularization modifying circuitry 125 can be used to assess the effect of dead filters as models are fine-tuned over time. For example, the identification of a particular dataset having a 50% filter death rate may not always present a problem in terms of model accuracy. However, if the same model is pre-trained for another more complex dataset, filter death begins to limit model accuracy as opposed to a model with fully functioning filters. As described in connection with FIG. 2, the regularization modifying circuitry 125 can be used to introduce a regularization loss that penalizes filters with low norms (e.g., which can occur when a convolution step is followed by an ReLU activation function).

The optimizing circuitry 130 can be used to change the attributes of a neural network (e.g., weights, learning rate, etc.) to reduce losses. For example, the optimizing circuitry 130 defines how the weights or learning rates can be changed using optimization algorithms to improve the accuracy of results. Such optimization algorithms can include gradient descent (e.g., used in linear regression, classification, backpropagation, etc.), which is dependent on the first order derivative of a loss function. For example, through backpropagation, loss can be transferred from one layer to another with the model's parameters (e.g., weights) modified to reduce the losses. Other optimizer-based algorithms can include stochastic gradient descent (SGD), mini-batch gradient descent, Momentum, Nesterov accelerated gradient, and adaptive moment estimation (Adam). SGD is a variant of gradient descent that updates the model's parameters more frequently, with the model parameters altered after computation of loss on each training sample. Momentum can be used to reduce high variance in the SGD algorithm and accelerate convergence towards a relevant direction, while the Nesterov accelerated gradient algorithm improves upon the Momentum algorithm by calculating the cost based on a future parameter rather than a current parameter. The Adam algorithm can rely on momentums of first and second order to accelerate the gradient descent algorithm by using exponentially weighted averages of the gradients to make the algorithm converge towards minima more quickly. Overall, the optimizing circuitry 130 selects an algorithm to implement for a given neural network training process. For example, the optimizing circuitry 130 can select an algorithm that uses the same update step in all parameters (e.g., SGD, Momentum, etc.) and/or the optimizing circuitry 130 can select an algorithm that applies different updates for each parameter and state of the training (e.g., RMSProp, Adagrad, Adam, and/or any variants of such algorithms). In some examples, the optimizing circuitry 130 can select an algorithm that permits fast convergence and decreased sensitivity to the selection of hyper-parameters.

FIG. 2 is a block diagram 200 of the regularization modifying circuitry 125 of FIG. 1 constructed in accordance with teachings of this disclosure. The regularization modifying circuitry 125 includes example data evaluation circuitry 202, example hyperparameter adjustment circuitry 204, example filter tracking circuitry 206, example settings modifying circuitry 208, example dead filter identifying circuitry 210, example survival loss calculation circuitry 212, example filter norm identifying circuitry 214, example threshold identifying circuitry 216, example output generating circuitry 218, and/or an example data storage 220. The data evaluation circuitry 202, the hyperparameter adjustment circuitry 204, the filter tracking circuitry 206, the settings modifying circuitry 208, the dead filter identifying circuitry 210, the survival loss calculation circuitry 212, the filter norm identifying circuitry 214, the threshold identifying circuitry 216, the output generating circuitry 218, and/or the data storage 220 are in communication using an example bus 222.

The data evaluation circuitry 202 performs evaluation of data input provided to the regularization modifying circuitry 125. In some examples, the data input includes information related to the neural network training results provided by the neural network training circuitry 102 of FIG. 1. For example, the data evaluation circuitry 202 is used to compare data output generated by the neural network training circuitry 102 to the target output (e.g., original input image data) to identify the presence of output inaccuracies (e.g., potential presence of dead filters). In some examples, the data evaluation circuitry 202 identifies additional information related to presence of dead filters (e.g., quantity of dead filters, percentage inaccuracy of neural network output data when compared to target output).

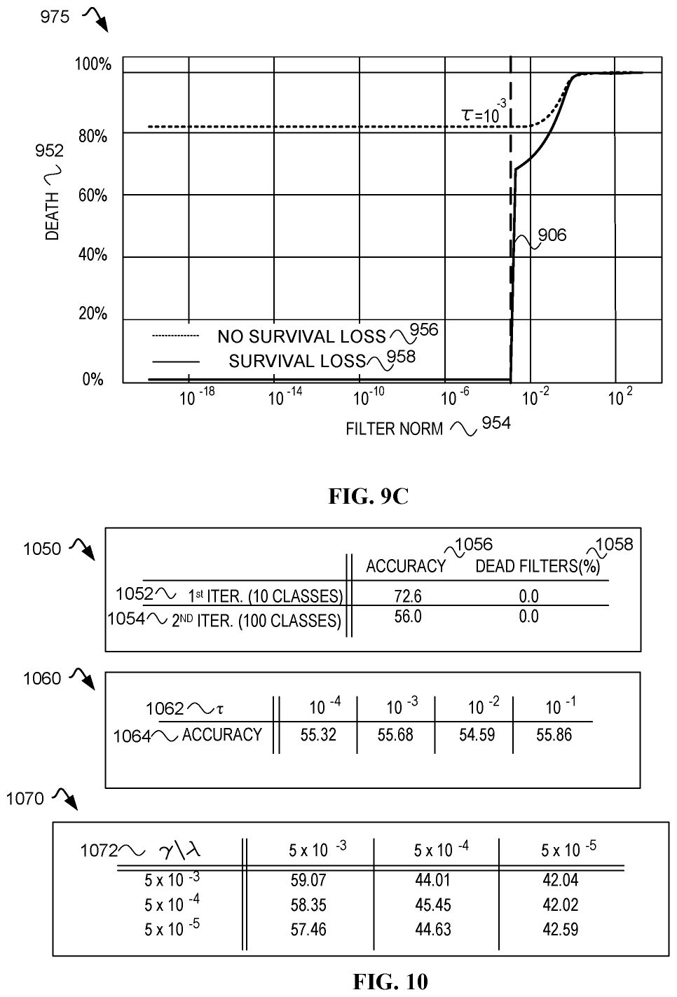

The hyperparameter adjustment circuitry 204 is used for tuning the hyperparameter(s) of a neural network. For example, the hyperparameter adjustment circuitry 204 tunes the hyperparameters of a residual neural network (ResNet) model on the given dataset (e.g., a CIFAR-10 dataset, which represents a collection of images commonly used to train machine learning and computer vision algorithms). For example, the hyperparameter adjustment circuitry 204 tunes the hyperparameters of a ResNet-110 model on the CIFAR-10 dataset using an Adam optimizer (e.g., based on optimizer selection performed by the optimizing circuitry 130) and an L2 regularizer (e.g., based on regularizer selection performed by the regularizing circuitry 120), as described in more detail in connection with FIG. 10.

The filter tracking circuitry 206 tracks filters to determine whether any of the filters are not detecting discriminative features in the input images. In some examples, the filter tracking circuitry 206 identifies filters that contain non-zero parameter values but do not get excited for any training sample (e.g., due to incorrect initialization, incorrect hyperparameter values, an increased learning rate, etc.). In some examples, such filters may not be unfunctional and instead can be activated during testing and/or become usable for other datasets. However, if the filter tracking circuitry 206 identifies filters that output all zero and/or near zero values, the dead filter identifying circuitry 210 can be used to assess filter death (e.g., filter functionality). Furthermore, the filter tracking circuitry 206 assesses whether previously dead filters become functional once adjustments are made (e.g., introduction of the survival loss function, adjustment in hyperparameters, etc.). As such, the filter tracking circuitry 206 is used for testing purposes to establish whether certain adjustments to the regularization process (e.g., using the regularization modifying circuitry 125) result in increased filter viability (e.g., as determined using filter death assessment).

The settings modifying circuitry 208 is used to modify network settings to decrease filter death (e.g., increase filter functionality). For example, the settings modifying circuitry 208 modifies settings that identify and/or reduce filter death. In some examples, the settings modifying circuitry 208 changes a regularizer (e.g., L1 regularizer, L2 regularizer, dropout regularizer, etc.) and/or optimizer (e.g., Adam optimizer, SGD Nesterov optimizer, etc.). As such, the settings modifying circuitry 208 adjusts the regularization modifying circuitry 125 process based on the optimizer and/regularizer selection. For example, the settings modifier 127 adjusts weight decay, epoch, and/or learning rate settings.

The dead filter identifying circuitry 210 identifies dead filters associated with a particular neural network. In some examples, the dead filter identifying circuitry 210 identifies dead filters based on whether a filter outputs zero values regardless of the input. For example, the dead filter identifying circuitry 210 determines which filters have an almost zero or zero filter norm value. In some examples, the dead filter identifying circuitry 210 determines whether a filtering step performed by the convolution circuitry 106 of FIG. 1 is followed by an ReLU activation function (e.g., presence of a dying ReLU). For example, the ReLU function includes an undefined derivative at zero and for negative values the derivative of the ReLU function is also zero. In the example of a convolution filter and an ReLU activation function, if the output of the convolution is zero, the gradient of the activation function is identified as zero. Such an event can impair training of the neural network using the neural network training circuitry 102 of FIG. 1, given that the gradient stops being backpropagated at that point. Additionally, during training the regularization modifying circuitry 125 continues to receive data input after regularization has been performed. For example, the neural network continues to be trained as part of continual learning.

The survival loss calculation circuitry 212 introduces a regularization loss that penalizes filters with low norms. For example, the survival loss calculation circuitry 212 calculates a function that can be used to improve accuracy in a simulated continual learning set-up. The survival loss calculation circuitry 212 determines a regularization term that can be used in combination with the regularizing circuitry 120 of FIG. 2 (e.g., L2 regularizer). For example, the survival loss calculation circuitry 212 identifies a regularization term that can be used to establish a balance between low magnitude parameters to improve generalization and living filters, thereby avoiding the loss of a network's full potential. In some examples, the survival loss calculation circuitry 212 identifies the survival loss function using the total number of filters in the network (e.g., determined using the filter tracking circuitry 206), the filter norm (e.g., identified using the filter norm identifying circuitry 214), and/or hyperparameter setting (e.g., determined using the hyperparameter adjustment circuitry 204). In some examples, the survival loss calculation circuitry identifies a total survival loss, including values for cross entropy loss, weight decay, and/or hyperparameters that control the impact of the survival loss function on the total loss function.

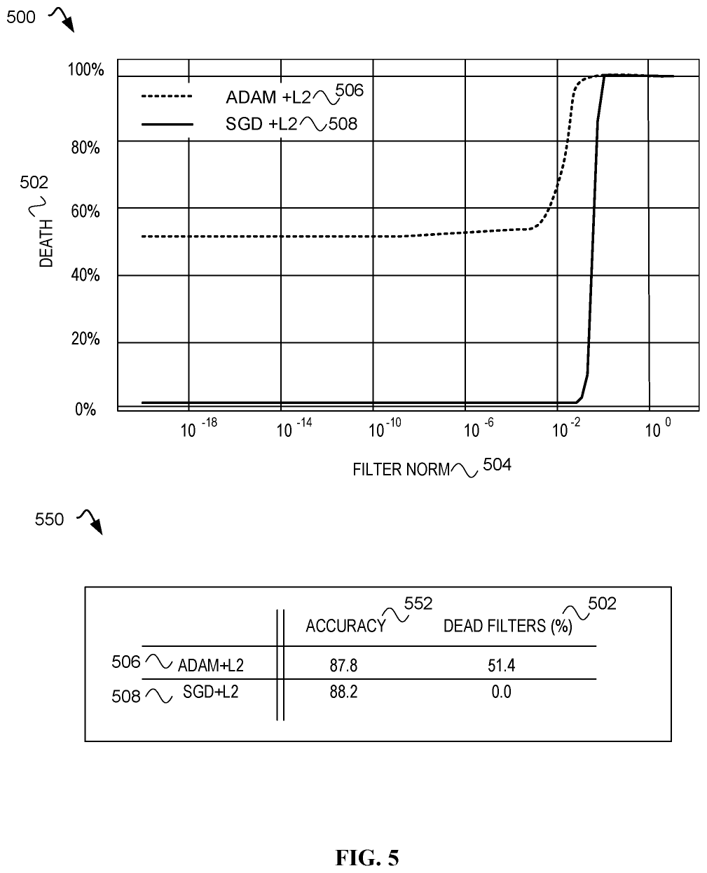

The filter norm identifying circuitry 214 monitors filter norm(s) during neural network training performed by the neural network training circuitry 102 of FIG. 1. For example, by monitoring filter norms, an assessment is performed of the contribution of various filters used by the convolution circuitry 106 of FIG. 1 to the outcome of the model training, especially when the filters used belong to the same layer of the neural network. For example, a combination of the Adam optimizer and the L2 regularizer has a negative effect on filter function in a convolutional neural network (CNN), as described in connection with FIGS. 5-8.

The threshold identifying circuitry 216 detects a filter norm threshold. For example, models are compared by setting a filter norm threshold of 10⁻¹⁵, such that filters with norms under a set threshold are identified as not being functional. As such, the threshold identifying circuitry 216 assists in the identification of dead filters by setting a specific filter norm threshold below which the filters are non-functional and/or above which threshold the filters are contributing to the final output.

The output generating circuitry 218 determines output results from assessment of filter death (e.g., accuracy of model, model filter death, etc.). In some examples, the output generating circuitry 218 interactively displays to a user the results of a network's filter assessment. In some examples, the output generating circuitry 218 outputs updated results when parameters are changed (e.g., adjustment of hyperparameters, regularizer adjustment, optimizer adjustment, updates to the number of layers used, training adjustments, etc.). In some examples, the output generating circuitry 218 outputs graphical and/or tabulated results to shown changes in filter performance.

The data storage 220 is used to store any information associated with the data evaluation circuitry 202, the hyperparameter adjustment circuitry 204, the filter tracking circuitry 206, the settings modifying circuitry 208, the dead filter identifying circuitry 210, the survival loss calculation circuitry 212, the filter norm identifying circuitry 214, and/or the threshold identifying circuitry 216. The example data storage 220 of the illustrated example of FIG. 2 can be implemented by any memory, storage device and/or storage disc for storing data such as flash memory, magnetic media, optical media, etc. Furthermore, the data stored in the example data storage 220 can be in any data format such as binary data, comma delimited data, tab delimited data, structured query language (SQL) structures, image data, etc.

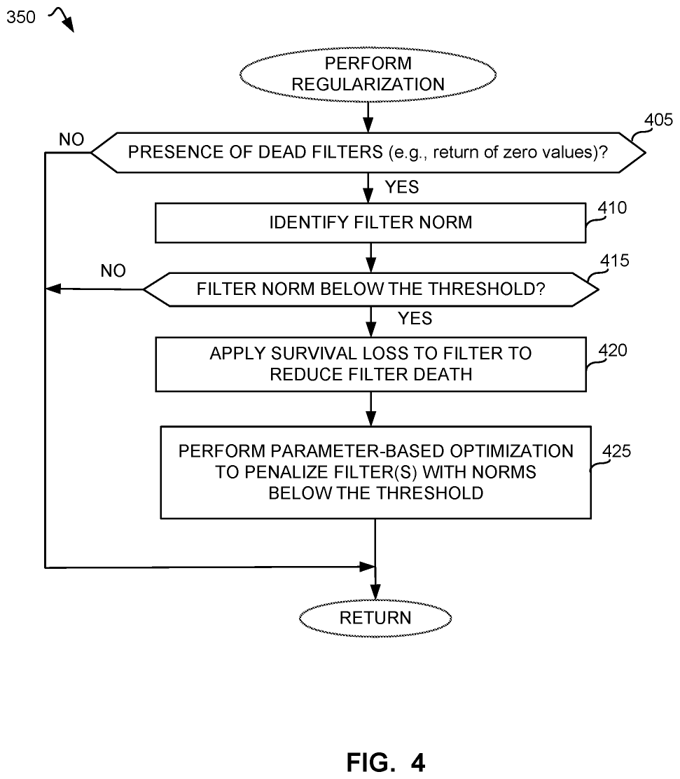

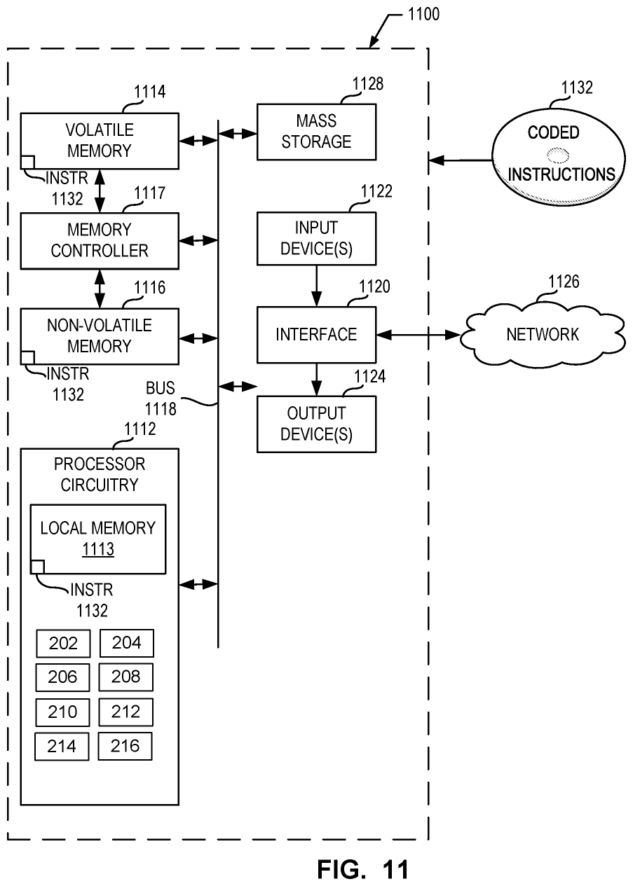

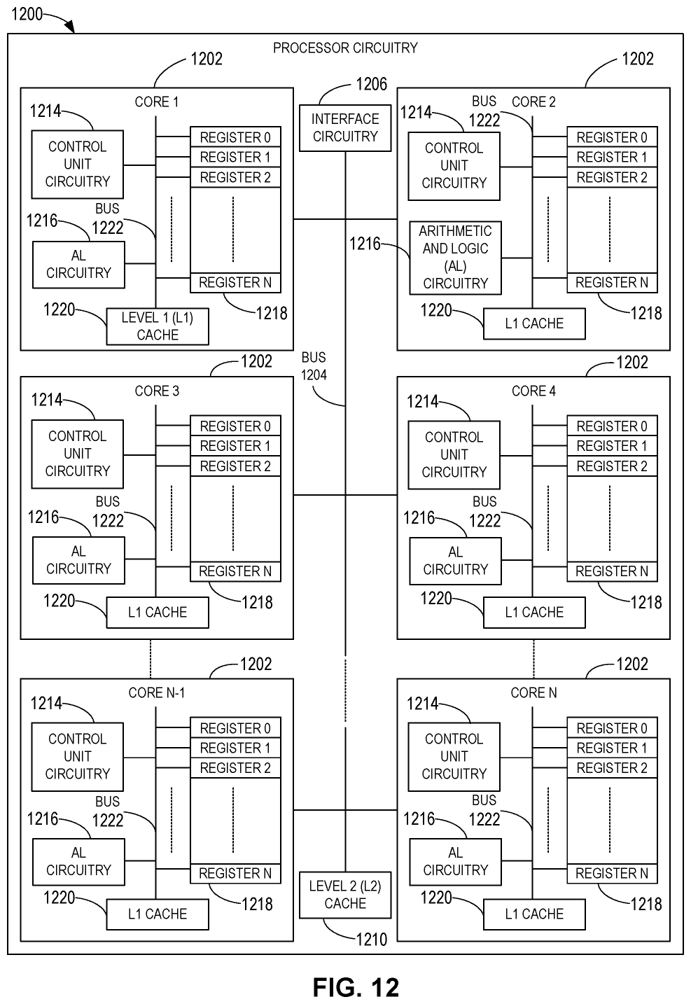

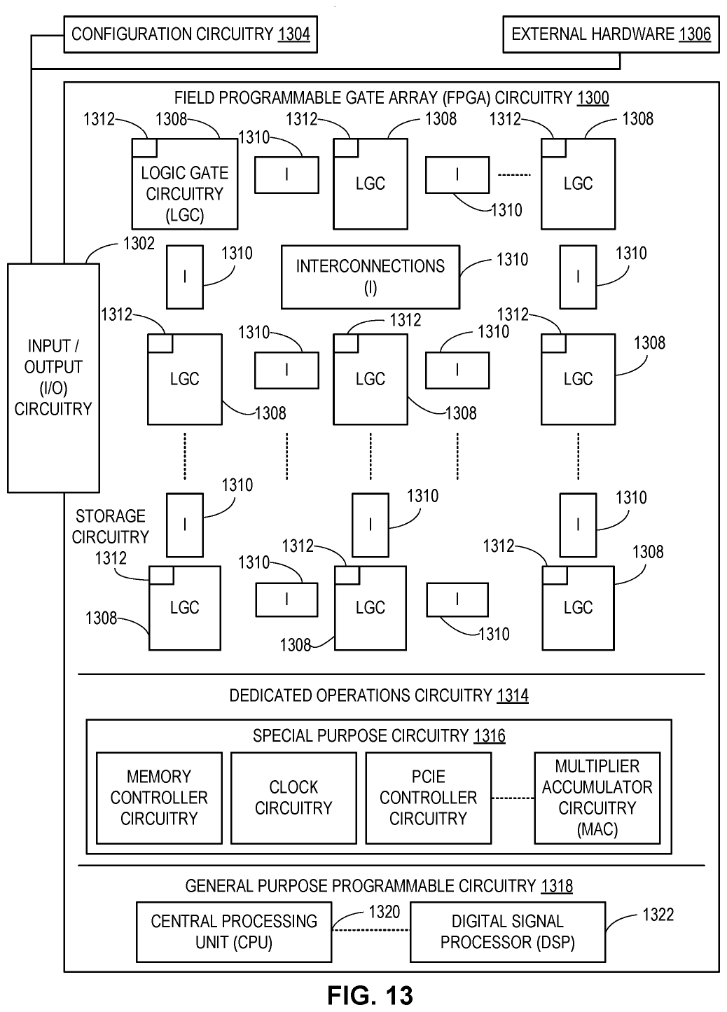

In some examples, the apparatus includes means for identifying at least one neural network filter. For example, the means for identifying may be implemented by filter tracking circuitry 206. In some examples, the filter tracking circuitry 206 may be implemented by machine executable instructions such as that implemented by at least blocks 405, 410 of FIG. 4 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the filter tracking circuitry 206 is implemented by other hardware logic circuitry, hardware implemented state machines, and/or any other combination of hardware, software, and/or firmware. For example, the filter tracking circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for correcting the filter norm values. For example, the means for correcting the filter norm values may be implemented by survival loss calculation circuitry 212. In some examples, the survival loss calculation circuitry 212 may be implemented by machine executable instructions such as that implemented by at least block 420 of FIG. 4 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the survival loss calculation circuitry 212 is implemented by other hardware logic circuitry, hardware implemented state machines, and/or any other combination of hardware, software, and/or firmware. For example, the survival loss calculation circuitry 212 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for reducing filter death. For example, the means for reducing filter death may be implemented by threshold identifying circuitry 216. In some examples, the threshold identifying circuitry 216 may be implemented by machine executable instructions such as that implemented by at least block 425 of FIG. 4 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the threshold identifying circuitry 216 is implemented by other hardware logic circuitry, hardware implemented state machines, and/or any other combination of hardware, software, and/or firmware. For example, the threshold identifying circuitry 216 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

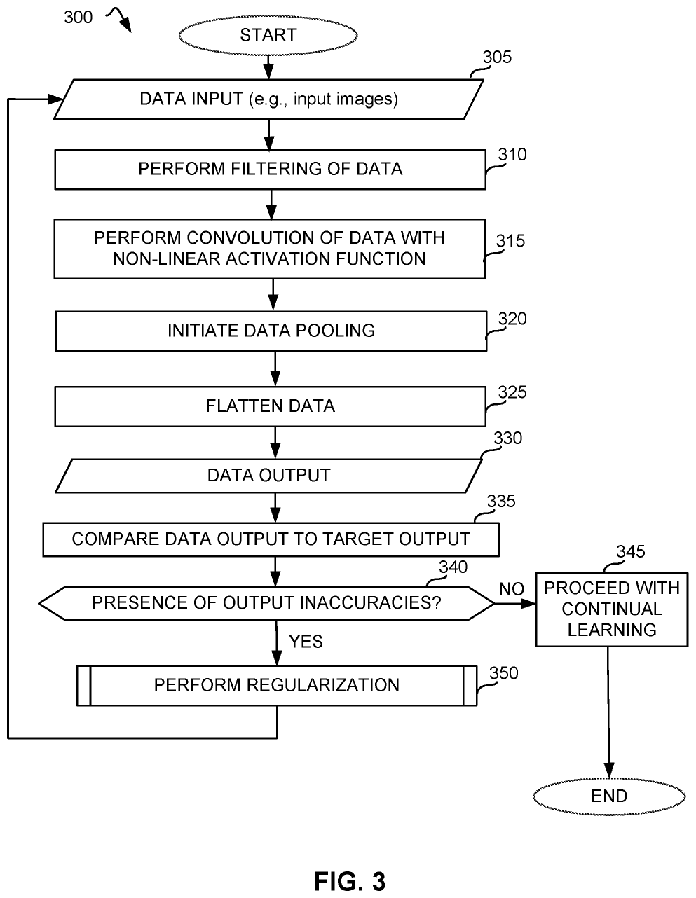

In some examples, the apparatus includes means for training the neural network. For example, the means for training the neural network may be implemented by neural network training circuitry 102. In some examples, the neural network training circuitry 102 may be implemented by machine executable instructions such as that implemented by at least block 345 of FIG. 3 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the neural network training circuitry 102 is implemented by other hardware logic circuitry, hardware implemented state machines, and/or any other combination of hardware, software, and/or firmware. For example, the neural network training circuitry 102 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for optimizing the neural network. For example, the means for optimizing the neural network may be implemented by optimizing circuitry 130. In some examples, the optimizing circuitry 130 may be implemented by machine executable instructions such as that implemented by at least block 425 of FIG. 4 executed by processor circuitry, which may be implemented by the example processor circuitry 1112 of FIG. 11, the example processor circuitry 1200 of FIG. 12, and/or the example Field Programmable Gate Array (FPGA) circuitry 1300 of FIG. 13. In other examples, the optimizing circuitry 130 is implemented by other hardware logic circuitry, hardware implemented state machines, and/or any other combination of hardware, software, and/or firmware. For example, the optimizing circuitry 130 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the regularization modifying circuitry regularization modifying circuitry 125 is illustrated in FIGS. 1 and 2, one or more of the elements, processes and/or devices illustrated in FIGS. 1 and 2 may be combined, divided, re-arranged, omitted, eliminated and/or implemented in any other way. Further, the example data evaluation circuitry 202, the example hyperparameter adjustment circuitry 204, the example filter tracking circuitry 206, the example settings modifying circuitry 208, the example dead filter identifying circuitry 210, the example survival loss calculation circuitry 212, the example filter norm identifying circuitry 214, the example threshold identifying circuitry 216, the example output generating circuitry 218, and/or, more generically, the example regularization modifying circuitry 125 of FIGS. 1-2 may be implemented by hardware, software, firmware and/or any combination of hardware, software and/or firmware. Thus, for example, any of the example data evaluation circuitry 202, the example hyperparameter adjustment circuitry 204, the example filter tracking circuitry 206, the example settings modifying circuitry 208, the example dead filter identifying circuitry 210, the example survival loss calculation circuitry 212, the example filter norm identifying circuitry 214, the example threshold identifying circuitry 216, the example output generating circuitry 218, and/or, more generically, the example regularization modifying circuitry 125 of FIGS. 1-2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data evaluation circuitry 202, the example hyperparameter adjustment circuitry 204, the example filter tracking circuitry 206, the example settings modifying circuitry 208, the example dead filter identifying circuitry 210, the example survival loss calculation circuitry 212, the example filter norm identifying circuitry 214, the example threshold identifying circuitry 216, the example output generating circuitry 218 is/are hereby expressly defined to include a non-transitory computer readable storage device or storage disk such as a memory, a digital versatile disk (DVD), a compact disk (CD), a Blu-ray disk, etc. including the software and/or firmware. Further still, the example regularization modifying circuitry 125 may include one or more elements, processes and/or devices in addition to, or instead of, those illustrated in FIGS. 1 and 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example machine readable instructions for implementing the example regularization modifying circuitry 125 are shown in FIGS. 3-4, respectively. The machine-readable instructions may be one or more executable programs or portion(s) of an executable program for execution by a processor such as the processor 1106 shown in the example processor platform 1100 discussed below in connection with FIG. 11. The program may be embodied in software stored on a non-transitory computer readable storage medium such as a CD-ROM, a floppy disk, a hard drive, a digital versatile disk (DVD), a Blu-ray disk, or a memory associated with the processor 1106, but the entire program and/or parts thereof could alternatively be executed by a device other than the processor 1106 and/or embodied in firmware or dedicated hardware. Further, although the example program is described with reference to the flowcharts illustrated in FIGS. 3-4, many other methods of implementing the regularization modifying circuitry 125 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 3 and/or 4 may be implemented using executable instructions (e.g., computer and/or machine readable instructions) stored on a non-transitory computer and/or machine readable medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of machine readable instructions 300 that may be executed by example processor circuitry to implement the regularization modifying circuitry 125 of FIGS. 1-2. In the example of FIG. 3, the neural network training circuitry 102 of FIG. 1 receives data input (e.g., input images used to train the network) (block 305). In some examples, the input images can include input images received as part of a dataset (e.g., CIFAR-10 dataset) which represents a collection of images commonly used to train machine learning and computer vision algorithms. Once the neural network training circuitry 102 receives the data input, the convolution circuitry 106 of FIG. 1 filters the data (block 310). In some examples, the filtering includes generation of feature maps or activation maps using activation functions (e.g., ReLU, softmax, etc.). In some examples, the convolution circuitry 106 identifies different features present in an image (e.g., horizontal lines, vertical lines, etc.). Once the filtering of data is performed, the convolution circuitry 106 of FIG. 1 performs convolution of data (e.g., using a non-linear activation function) (block 315). For example, the convolution circuitry 106 generates feature maps for each layer of the neural network. The convolution circuitry 106 applies a convolution operation to the input for passing the results to the next layer of the neural network. The pooling circuitry 108 of FIG. 1 can initiate data pooling to reduce the spatial size of the convoluted feature(s) (block 320). In some examples, the pooling circuitry 108 combines output(s) of a neuron cluster in one layer into a single neuron in a subsequent layer, reducing the size of an output from a previous layer of the CNN (e.g., using maximum pooling, average pooling, etc.). Once pooling is complete, the flattening circuitry 110 flattens the input (block 325). While in the example of FIG. 3 the pooling step is performed before the flattening, these step orders are not limiting. For example, convolution and/or pooling steps are operations that alternate within a model architecture and thereby a pooling step can occur before a convolution step and/or vice versa. In some examples, several convolutions can be performed follow by a single pooling step, with additional convolutions followed by another pooling step, and so on.

In some examples, flattening can be used to create a one-dimensional linear vector to serve as further input into the model during continuous training, as represented by the data output occurring after the flattening is performed (block 330). In some examples, the regularizing circuitry 120 and/or the regularization modifying circuitry 125 can be used to determine whether the data output from the neural network training circuitry 102 matches the intended data output result (e.g., comparing the data output to target data output as determined using the original input data images) (block 335). If the regularizing circuitry 120 and/or the regularization modifying circuitry 125 identifies the presence of input inaccuracies (block 340), the regularization modifying circuitry 125 can be engaged by the regularizing circuitry 120 to identify and/or eliminate dead filters through the regularization process of FIG. 4 (block 350). If the presence of output inaccuracies is not identified, the neural network can proceed with training without adjustment of filters (block 345). In some examples, control returns to the regularizing circuitry 120 to determine which regularizer (e.g., L1, L2, etc.) should be used in combination with the optimizing circuitry 130 (e.g., Adam, SGD Nesterov, etc.). In some examples, the regularizing circuitry 120 and/or optimizing circuitry 130 selection is performed before the training data output is provided to the regularization modifying circuitry 125.

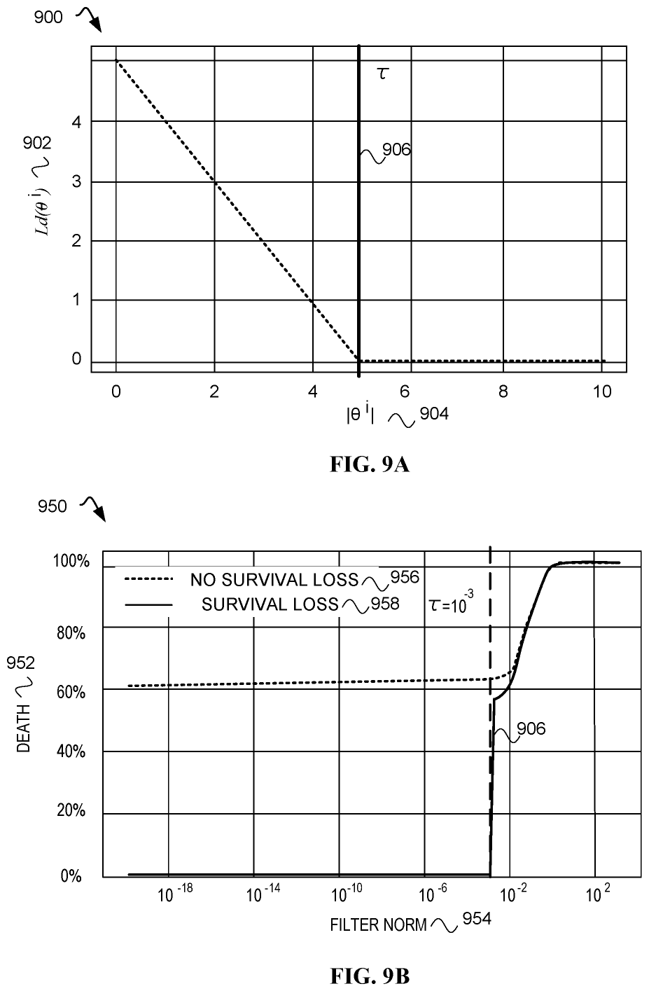

FIG. 4 is a flowchart representative of machine readable instructions 350 that may be executed by example processor circuitry to perform regularization during the neural network training process using the regularization modifying circuitry 125 of FIGS. 1-2. In some examples, data output is provided to the regularization modifying circuitry 125 from the regularizing circuitry 120 (e.g., L1, L2, etc.) and/or the optimizing circuitry 130 (e.g., Adam, SGD Nesterov, etc.). In some examples, the dead filter identifying circuitry 210 determines the presence of dead filters (block 405). In some examples, the filter tracking circuitry 206 identifies filters for assessment (e.g., filters returning near zero-values, filters returning zero values, etc.) and the dead filter identifying circuitry 210 performs assessment of the total number of dead filters. In some examples, the filter norm identifying circuitry 214 identifies the filter norm value for a given filter (block 415). For example, the return of zero values can be an indication of filter death. In some examples, a threshold identifying circuitry 216 can be used to identify whether filter norm is below or above the threshold to determine whether a survival loss function should be applied to a given filter to reduce filter death. As such, if the filter norm identifying circuitry 214 determines that the filter norm is below the filter norm threshold (block 415), the survival loss calculation circuitry 212 is used to calculate a survival loss function and/or a total loss function and apply the survival loss function to the filter to reduce filter death (block 420). However, if the filter norm identifying circuitry 214 determines that the filter norm is not below the threshold, control returns to the neural network training circuitry 102. In some examples, the regularization modifying circuitry 125 performs parameter-based optimization using the hyperparameter adjustment circuitry 204 to penalize filter(s) with norms that are below the threshold (block 425). For example, the hyperparameter adjustment circuitry 204 can tune the hyperparameters of a residual neural network (ResNet) model on the given dataset (e.g., a CIFAR-10 dataset), as described in more detail in connection with FIGS. 9A, 9B, 9C, and 10.

FIG. 5 illustrates an example graphical comparison 500 and an example tabulated comparison 550 of model filter norms for models trained using different optimizers (e.g., Adam, SGD Nesterov) in combination with an L2 regularizer. In the example of FIG. 5, example filter death(s) 502 are determined for example filter norm(s) 504. In some examples, the filter norm identifying circuitry 214 can be used by the regularization modifying circuitry 125 to quantify the filter norm value(s), while the dead filter identifying circuitry 210 can be used to quantify the percentage of dead filters. In the example of FIG. 5, an initial learning rate (e.g., learning rate of 10⁻²) can be used with an epoch decay setting (e.g., learning rate decay of 10 every 40 epochs) and/or a weight decay setting (e.g., 5×10⁻⁴) for a particular batch size (e.g., mini-batch size of 208) for a neural network model. In the example of FIG. 5, such settings result in the model reaching an accuracy of 87.8% during testing for an example first optimizer/regularizer combination 506 (e.g., Adam optimizer and L2 regularizer). Additionally, the same neural network model can be trained using a second optimizer/regularizer combination 508 (e.g., SGD Nesterov with Momentum 0.9 as the optimizer and L2 as the regularizer). In the example graphical comparison 500 of FIG. 5, such settings using the second optimizer/regularizer combination results in the model reaching an accuracy of 88.2%. The tabulated comparison 550 presents example accuracy results 552 and the corresponding filter death(s) 502 for each of the optimizer/regularizer combinations (e.g., first combination 506 and second combination 508). While both models reach similar accuracies (e.g., 87.7% for the first optimizer/regularizer combination 506 versus 88.2% for the second optimizer/regularizer combination 508). However, there are significant differences between the filter death(s) of the two different optimizer/regularizer combinations (e.g., 51.4% for the first optimizer/regularizer combination 506 versus 0.0% for the second optimizer/regularizer combination 508). In the example of FIG. 5, both models are compared in terms of their filter norms. For example, FIG. 5 shows the percentage of filters out of the total filters in the network (e.g., represented by filter death 502) with a norm value under a threshold (e.g., represented by filter norm 504). In some examples, filters with norms under 10⁻¹⁵ can have a meaningless contribution to the test accuracy and therefore can be considered dead filters. In the example of FIG. 5, the tabulated comparison 550 indicates a difference of more than 50% in the presence of filter death between the two optimizer/regularizer combinations 506, 508 despite a difference of only 0.4 points in the test accuracy of the models.

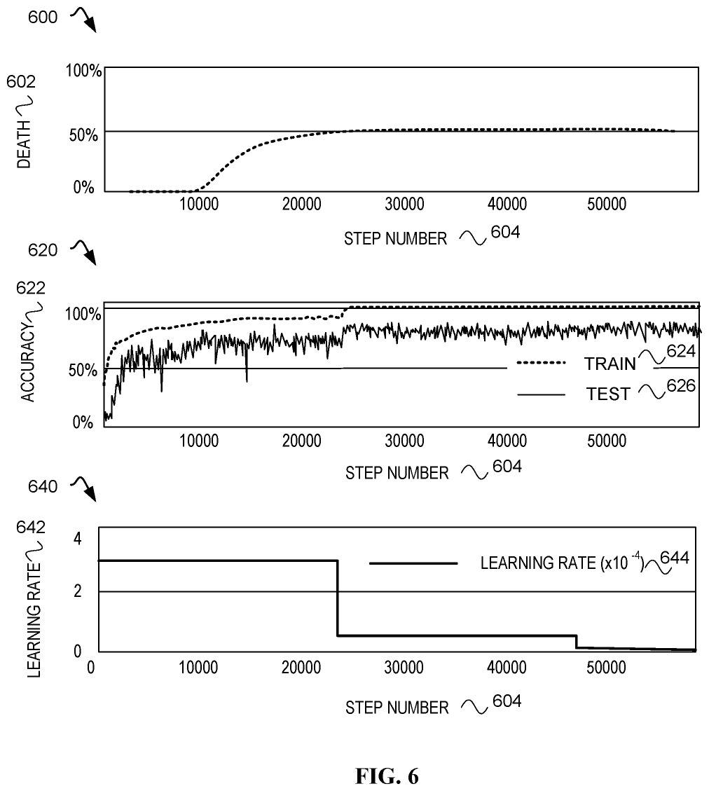

FIG. 6 illustrates example graphical representation(s) 600, 620, 640 of reduction of filter norms over time using the Adam optimizer in combination with the L2 regularizer (e.g., representing the first optimizer/regularizer combination 506). In the example of FIG. 6, an example first graphical representation 600 includes an example filter death 602 and an example step number 604. The death rate 602 corresponds to filter death as described in connection with FIG. 5, while the step number corresponds to neural network training steps. In some examples, an earlier stop to the training (e.g., at a particular step number) could be implemented to mitigate the occurrence of filter death. As shown in the first graphical representation 600, filter death 602 begins to increase after a step number 604 of approximately 10,000, reaching a continuous filter death rate of 50% as the step number 604 continues to increase. An example second graphical representation 620 of FIG. 6 further illustrates training and testing accuracy results for the Adam optimizer in combination with the L2 regularizer (e.g., representing the first optimizer/regularizer combination 506), including the step number 604 and corresponding example accuracy 622 results. In the example of the second graphical representation 620, example training data 624 and testing data 626 indicates that accuracy 622 increases as the step number 604 increases, reaching a maximum of approximately 100% accuracy for the training data 624 and a maximum of approximately 80% for the testing data 626. An example third graphical representation 640 of FIG. 6 illustrates example learning rate 642 results over an increasing number of training steps (e.g., step number 604), based on an example learning rate 644, thereby representing the learning rate schedule for the entire training period. The learning rate schedule can be used to adjust the learning rate during training by reducing the learning rate according to a pre-defined schedule, as shown in the third graphical representation 640. Learning rate schedules can include time-based decay, step decay, and/or exponential decay. Based on the graphical representation(s) 600, 620, 640, a particular match is difficult to obtain based on the training steps (e.g., to indicate when an overfit is reached) and/or the learning rate schedule. As such, it can be challenging to determine after how many training steps (e.g., step number 604) the training process should be stopped to reduce filter death 602 based on the accuracy data and learning rate schedules. Methods and apparatus disclosed herein reduce filter death using the regularization modifying circuitry 125, as described in greater detail in connection with FIGS. 9A, 9B, 10A, 10B.

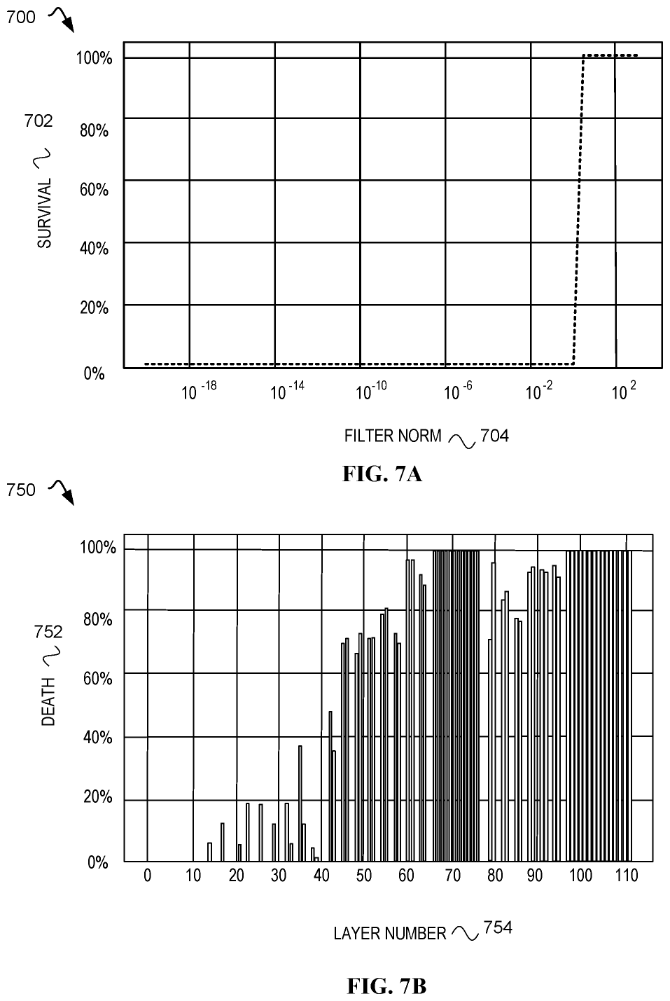

FIG. 7A illustrates an example graphical representation 700 of a model filter norm resulting from training using an Adam optimizer without an L2 regularizer. In the example of FIG. 7A, filter survival (e.g., as shown using example survival 702) is not decreased when filter norm 704 is increased in the absence of the L2 regularizer (e.g., use of the Adam optimizer alone), although the test accuracy can show a slight decrease (e.g., 74.8% as compared to 87.8% accuracy obtained with the use of the Adam optimizer in combination with the L2 regularizer). Such a result indicates that the use of the L2 regularizer in conjunction with adaptive learning rate optimizers (e.g., such as Adam) contribute to filter death. FIG. 7B illustrates an example graphical representation 750 of the status of dead filters across layers of a neural network, indicating higher percentage of filter death in deeper layers compared to shallower layers of the neural network. In the example of FIG. 7B, filter death 752 is assessed across layers (e.g., designated using layer number 754). In the graphical representation 750, the percentage of filters with norms lower than 10⁻¹⁵ per layer is shown, the layers sorted from left to right according to filter depth (e.g., from the shallowest filter to the deepest filter). Based on the results of FIG. 7B, the deepest layers (e.g., layer numbers 70-110) have higher percentages of filters deaths (e.g., filter death 752) compared to the shallower layers (e.g., layer numbers 0-40). Dead filters with norms close to zero are particularly damaging because such filters have no chance of being revived. In the example of static datasets, such filter death may not be significant if the accuracy is acceptable for a given use case. However, for a continual learning methodology where the dataset becomes more complex over time, a higher percentage of the overall network is needed to solve a particular problem associated with a given training task. As such, filter death can present limitations in continual learning scenarios.

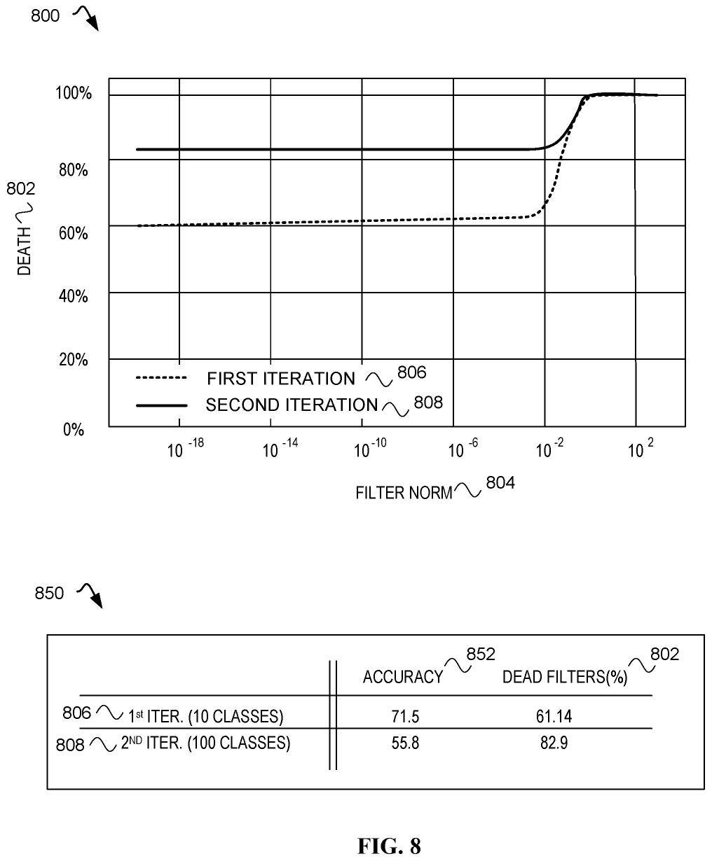

FIG. 8 illustrates an example graphical representation 800 of a percentage of filter death for a first and a second iteration during model training using an Adam optimizer in combination with an L2 regularizer. In the example of FIG. 8, filter death 802 is quantified for a variety of filter norms 804, including using a first iteration 806 and/or a second iteration 808. For example, to simulate a continual learning scenario, a CIFAR-100 dataset can be split into two iterations, the first iteration 806 and the second iteration 808. In some examples, the first iteration 806 can contain a reduced number of classes (e.g., 10 classes), while the second iteration 808 can add on an increased number of classes (e.g., remaining 90 classes). In some examples, the use of a first and a second iteration permits an extension of the results to more complex configurations regardless of the number of iterations if the dataset increases in complexity overtime. In the example of FIG. 8, two models are trained in sequence using the Adam optimizer in combination with the L2 regularizer. In the first iteration 806, an initial learning rate can be established (e.g., a learning rate of 10⁻² which decays by 10 every 40 epochs). A weight decay can be set together with a specified batch size (e.g., a weight decay of 5×10⁻⁴ and a batch size of 208 for training over 150 epochs). In the second iteration 808, weights can be loaded from the first model, with parameters from the 10 classes of the previous model merged into the current model for the classification layer, with the remaining parameters initialized using an initialization process (e.g., Xavier initialization, etc.). In some examples, cross-validation of weight decay and/or learning rate can be performed using the Adam optimizer and/or L2 regularizer. In the graphical representation 800, lower filter death 802 is observed for the first iteration 806 initially (e.g., for filter norms from 10⁻¹⁸ to 10⁻²). An example tabulated representation 850 of the data indicates that example accuracy 852 is higher (e.g., 71.5) for the first iteration 806 compared to the second iteration 808, which shows a reduced accuracy 852 (e.g., 55.8). The number of dead filters 802 is likewise greater for the second iteration 808 (e.g., 82.9%) compared to the first iteration 806 (e.g., 61.14%). An increase in model accuracy requires a reduction of filter death, such that all filters from the network are active. Methods and apparatus disclosed herein introduce the use of a regularization modifying circuitry 125 to allow for fully functional networks (e.g., elimination and/or reduction of filter death). For example, the regularization modifying circuitry 125 can add a regularizer in the total loss to penalize filters with small norms, with the goal of keeping the filters alive (e.g., reduce presence of non-zero output). For example, the survival loss calculation circuitry 212 can include a survival loss function to eliminate presence of dead filters. In some examples, filters may be alive but may not contribute to a particular dataset. However, such filters have the potential to be used in future datasets and are otherwise more useful than filters that are dead.

FIG. 9A illustrates an example graphical representation 900 of a survival loss function. In some examples, the survival loss can be expressed in the form of Equation 1:

$${ℒ}_{s} ( {θ}^{i} ) = {\sum }_{i}^{N} max ( 0 , τ - ‖ {θ}^{i} ‖ ) , \qquad ( 1 )$$

In the example of Equation 1, θⁱ represents an i^{th} filter of the network, N represents the total number of filters in the network, ∥⋅∥ represents the norm, and τ represents a hyperparameter that defines the minimum norm of a filter to be penalized and/or the maximum penalization for the filter. In some examples, the penalization increases linearly from 0 if the norm is higher than τ and/or the penalization increases linearly to τ if the norm is zero. The graphical representation 900 represents the survival loss function of Equation 1, including an example loss function output for an i^{th} filter of the network 902 and an example filter norm 904 (e.g., example filter norm (e.g., ∥θⁱ∥), including an example hyperparameter 906 defining a minimum norm of a filter to be penalized (e.g., τ). In some examples, the survival loss function of Equation 1 can be used in combination with the L2 regularizer (e.g., regularizing circuitry 120 of FIG. 1) to identify a balance between low weight magnitudes that improve generalization and/or magnitudes that are too low and thereby prone to cause filter death. As such, a total loss function can be defined using Equation 2:

[symbol]

(x,y,Θ)= [symbol] ₓₑ(x,y,Θ)+λ [symbol] _{L2}(θ)+γ [symbol] ₛ(θ), (2)

In the example of Equation 2, where Lₓₑ represents a cross entropy loss, λ represents a weight decay for the L2 loss, and γ represents a hyperparameter that controls the impact of the survival loss function Lₛ (θⁱ) in the total loss function L(x, y, θ). FIG. 9B illustrates an example first iteration graphical representation 950 of example filter death 952 for an example filter norm 954 during a first iteration with and without the use of the survival loss function (e.g., without survival loss 956 and with survival loss 958). While FIG. 9B represents results for a first iteration, FIG. 9C is an example graphical representation 975 of results for a second iteration. In the examples of FIGS. 9B and 9C, the use of a survival loss function significantly reduces and/or eliminates filter death when compared to the absence of a survival loss function for both the first iteration and the second iteration.

FIG. 10 illustrates example tabulated results 1050, 1060, 1070 associated with decreased filter death in the presence of a survival loss function, including the influence of hyperparameters on accuracy. In the tabulated result 1050, a comparison of the two models trained with survival loss in connection with FIGS. 9B and 9C indicates results for a first iteration 1052 and a second iteration 1054, with example accuracy data 1056 and dead filter data 1058 (e.g., the models trained using an Adam optimizer with an L2 regularizer and a survival loss function in continuous mode for a first and second split CIFAR-100). These data indicate that the survival loss function keep the filters alive (e.g., filter death 1058 is 0.0) and improves the accuracy results not only in the second iteration 1054 (e.g., accuracy of 56.0) but also in the first iteration 1052 (e.g., accuracy of 72.6). Furthermore, hyperparameters of the survival loss can be validated by identifying a first parameter τ that controls the norm of the filters, and a second parameter © responsible for the impact of the survival loss in the total loss. In some examples, the first or the second parameter can be studies in isolation while the remaining parameter(s) are set to a reasonable value. In the examples disclosed herein, τ is assessed in isolation, followed by an assessment of © in combination with the weight decay └ of the K2 regularizer. For example, τ can represent a minimum norm for the filters to avoid being penalized, such that filters with norms lower than τ are penalized. In some examples, τ can define a maximum penalization to be applied for zero norm filters. The tabulated results 1060 of FIG. 6 indicate that τ (e.g., first parameter 1062) shows high robustness to a wide range of different values, with example accuracy results 1064 ranging from 54.59-55.86. For example, the models shown in connection with tabulated results 1060 can be trained on CIFAR-100 for 100 epochs (e.g., using the Adam optimizer in combination with L2 regularizer and the survival loss function, where └=5×10⁻⁴ and ©=5×10⁻⁴, and an initial learning rate of 10⁻² that decays 1 order of magnitude every 40 epochs). In some examples, the regularizer (e.g., L2 regularizer) and/or the survival loss function can push the parameters in opposite directions during training. For example, while the regularizer can push the parameters to have low magnitudes, the survival loss function can penalize the low norms of the filters. However, the regularizer (e.g., L2 regularizer) can act at a parameter level while the survival loss function acts at a filter level. Additionally, the regularizer can continuously act on all parameters during the training process, while the survival loss function can affect certain parameters of the network and at specific moments during training (i.e., when the filter norm is below the threshold). As such, while the regularizer can improve generalization by keeping parameter magnitudes low, survival loss avoids filter death.

Based on the tabulated results 1070 of FIG. 10, where accuracy results are shown in connection with an example parameter ration 1072 (e.g., parameter ratio ©/└), parameter └ shows greater sensitivity in terms of accuracy, with significant correlation between lower values of the parameter and lower accuracies. Likewise, parameter © presents a more robust behavior with respect to accuracy, keeping the accuracy at an overall constant for the same values of └. As such, the selection of hyperparameters can be modified based on the desired reduction in total filter death using the survival loss function.

FIG. 11 is a block diagram of an example processor platform 1100 structured to execute and/or instantiate the machine readable instructions and/or operations of FIG. 10 to implement the regularization modifying circuitry 125 of FIG. 2. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the data evaluation circuitry 202, the hyperparameter adjustment circuitry 204, the filter tracking circuitry 206, the settings modifying circuitry 208, the dead filter identifying circuitry 210, the survival loss calculation circuitry 212, the filter norm identifying circuitry 214, the threshold identifying circuitry 216, and/or the output generating circuitry 218.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1122 are connected to the interface circuitry 1120. The input device(s) 1122 permit(s) a user to enter data and/or commands into the processor circuitry 1112. The input device(s) 1102 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output devices 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 11206. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1132, which may be implemented by the machine readable instructions of FIGS. 3-4, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may implement multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 3-4.

The cores 1202 may communicate by an example bus 1204. In some examples, the bus 1204 may implement a communication bus to effectuate communication associated with one(s) of the cores 1202. For example, the bus 1204 may implement at least one of an Inter-Integrated Circuit (I2C) bus, a Serial Peripheral Interface (SPI) bus, a PCI bus, or a PCIe bus. Additionally or alternatively, the bus 1204 may implement any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the L1 cache 1220, and an example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The bus 1222 may implement at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 3-4 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 3-4. In particular, the FPGA 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 3-4. As such, the FPGA circuitry 1300 may be structured to effectively instantiate some or all of the machine readable instructions of the flowcharts of FIGS. 3-4 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 3-4 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware (e.g., external hardware circuitry) 1306. For example, the configuration circuitry 1304 may implement interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may implement the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and interconnections 1310 are configurable to instantiate one or more operations that may correspond to at least some of the machine readable instructions of FIGS. 3-4 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 6 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 3-4 may be executed by one or more of the cores 1202 of FIG. 12 and a second portion of the machine readable instructions represented by the flowchart of FIGS. 3-4 may be executed by the FPGA circuitry 1300 of FIG. 13.

In some examples, the processor circuitry 1112 of FIG. 11 may be in one or more packages. For example, the processor circuitry 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

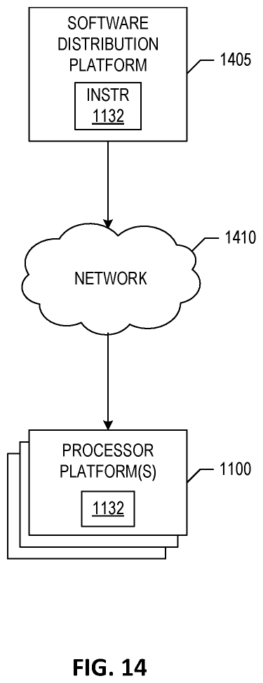

A block diagram illustrating an example software distribution platform 1405 to distribute software such as the example machine readable instructions 1212 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1212 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1212, which may correspond to the example machine readable instructions of FIGS. 3-4, as described above. The one or more servers of the example software distribution platform 1405 are in communication with a network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1212 from the software distribution platform 1405. For example, the software, which may correspond to the example machine readable instructions of FIGS. 3-4, may be downloaded to the example processor platform 1100, which is to execute the machine readable instructions 1212 to implement the regularization modifying circuitry 125 of FIG. 2. In some example, one or more servers of the software distribution platform 1405 periodically offer, transmit, and/or force updates to the software (e.g., the example machine readable instructions 1212 of FIG. 11) to ensure improvements, patches, updates, etc., are distributed and applied to the software at the end user devices.

From the foregoing, it will be appreciated that example systems, methods, and apparatus allow for the reduction of filter death in machine learning models. For example, a large percentage of dead filters can be present with the use of select optimizers (e.g., higher percentage of dead filters when using an adaptive optimizer compared a non-adaptive optimizer). Presence of dead filters in a model is a potential problem if that model is pre-trained for use in another dataset (e.g. as part of continual learning). Methods and apparatus disclosed herein introduce a regularization term (e.g., a survival loss function) to reduce dead filters. In some examples, the survival loss function disclosed herein can be used in combination with an existing regularizer to identify a balance between low magnitude parameters for improved generalization to avoid losing the full potential of the neural network. Additionally, in the examples disclosed herein, parameter-based optimization can be used to penalize filter(s) with norms that fall below an established threshold, thereby reducing the impact of poorly performing filters with high percentages of filter death. As such, methods and apparatus disclosed herein can be used to improve the accuracy and efficiency of neural network training (e.g., CNN-based training) during continual learning by applying a regularization loss to penalize a filter with low norms to prevent loss of filter functionality resulting in an inability to discriminate input data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus, comprising:
at least one memory;
instructions in the apparatus; and
processor circuitry to execute the instructions to:
identify at least one neural network filter with filter norm values below a filter norm threshold, the filter norm values corresponding to filter functionality, a higher level of filter functionality corresponding to decreased filter death;
correct the filter norm values by applying a survival loss function, the survival loss function including one or more hyperparameters;
reduce filter death by adjusting the one or more hyperparameters used to define a minimum filter norm for identification of filter functionality, the adjustment based on neural network filter performance, a functional filter to return non-zero parameter values indicating reduction of filter death; and
train the neural network for use in continual learning with the at least one neural network filter corrected using the survival loss function.

2. The apparatus of claim 1, wherein the processor circuitry is to optimize the neural network using an adaptive learning rate optimizer.

3. The apparatus of claim 2, wherein the adaptive learning rate optimizer is an Adam optimizer, the Adam optimizer used in conjunction with an L2 regularizer.

4. The apparatus of claim 1, wherein the survival loss function includes at least one term for a total number of filters in the neural network, a filter norm, or the one or more hyperparameters defining the minimum filter norm.

5. The apparatus of claim 1, wherein the neural network is a residual neural network.

6. The apparatus of claim 1, wherein the processor circuitry is to determine a total loss function, the total loss function a regularizer-based loss function including the survival loss function to decrease filter death.

7. The apparatus of claim 6, wherein the total loss function includes at least one of a cross entropy loss, weight decay, or a survival loss impact hyperparameter.

8.-14. (canceled)

15. A non-transitory computer readable storage medium comprising computer readable instructions which, when executed, cause a processor to at least:
identify at least one neural network filter with filter norm values below a filter norm threshold, the filter norm values corresponding to filter functionality, a higher level of filter functionality corresponding to decreased filter death;
correct the filter norm values by applying a survival loss function, the survival loss function including one or more hyperparameters;
reduce the filter death by adjusting the one or more hyperparameters used to define a minimum filter norm for identification of filter functionality based on neural network filter performance, a functional filter to return non-zero parameter values indicating reduction of filter death; and
train the neural network for use in continual learning with the at least one or more neural network filter corrected using the survival loss function.

16. The non-transitory computer readable storage medium as defined in claim 15, wherein the computer readable instructions, when executed, cause the one or more processors to optimize the neural network using an adaptive learning rate optimizer.

17. The non-transitory computer readable storage medium as defined in claim 16, wherein the adaptive learning rate optimizer is an Adam optimizer, the Adam optimizer used in conjunction with an L2 regularizer.

18. The non-transitory computer readable storage medium as defined in claim 15, wherein the neural network is a residual neural network.

19. The non-transitory computer readable storage medium as defined in claim 16, wherein the computer readable instructions, when executed, cause the one or more processors to determine a total loss function, the total loss function a regularizer-based loss function including the survival loss function to decrease filter death.

20. The non-transitory computer readable storage medium as defined in claim 19, wherein the total loss function includes at least one of a cross entropy loss, weight decay, or a survival loss impact hyperparameter.

21. An apparatus, comprising:
means for identifying at least one neural network filter with filter norm values below a filter norm threshold, the filter norm values corresponding to filter functionality, a higher level of filter functionality corresponding to decreased filter death;
means for correcting the filter norm values by applying a survival loss function,
the survival loss function including one or more hyperparameters;
means for reducing filter death by adjusting the one or more hyperparameters used to define a minimum filter norm for identification of filter functionality, the adjustment based on neural network filter performance, a functional filter to return non-zero parameter values indicating reduction of filter death; and
means for training the neural network for use in continual learning with the at least one neural network filter corrected using the survival loss function.

22. The apparatus of claim 21, further including means for optimizing the neural network using an adaptive learning rate optimizer.

23. The apparatus of claim 22, wherein the adaptive learning rate optimizer is an Adam optimizer, the Adam optimizer used in conjunction with an L2 regularizer.

24. The apparatus of claim 21, wherein the survival loss function includes at least one term for a total number of filters in the neural network, a filter norm, or the one or more hyperparameters defining the minimum filter norm.

25. The apparatus of claim 21, wherein the neural network is a residual neural network.

26. The apparatus of claim 21, wherein the means for correcting the filter norm values further includes determining a total loss function, the total loss function a regularizer-based loss function including the survival loss function to decrease filter death.

27. The apparatus of claim 26, wherein the total loss function includes at least one of a cross entropy loss, weight decay, or a survival loss impact hyperparameter.
